(19) United States
(12) Patent Application Publication
(10) Pub. No.: US 2002/0001448 A1
(43) Pub. Date: Jan. 3, 2002

(54) SELECTIVE RECORDING AND REPRODUCTION OF VIDEO PROGRAMS ACCORDING TO VIDEO PROGRAMS ACCORDING TO VIDEO PROGRAM GRADING

(75) Inventor: SEOK HWA JEONG, KUMI (KR)

Correspondence Address: OPPENHEIMER, WOLFF & DONNELLY LLP, ATTENTION: CHARLES BERMAN, ESQ, 2029 CENTURY PARK EAST 38TH FLOOR, LOS ANGELES, CA, 90067-3024, US

(73) Assignee: LG Electronics, Inc., Seoul (KR)

(21) Appl. No.: 08/889,621

(22) Filed: Jul. 8, 1997

(30) Foreign Application Priority Data
Jul. 10, 1996 (KR) P96-27736
Jul. 10, 1996 (KR) P96-27737

(51) Int. Cl. H04N 5/92; H04N 5/781

(52) U.S. Cl. 386/46; 386/125

(57) ABSTRACT

A device for selectively recording and reproducing video programs for video appliances capable of grading adult programs of violence and sex distributed through diverse video media and restricting juveniles' viewing of those programs. In recording, a viewing-restriction step (grade) is determined in accordance with the contents of a video program to be recorded, and the program provided from one of the video appliances is recorded on a recording medium in accordance with the determined recorded control step. In reproduction, the record control step cf the program recorded on the recording medium is recognized, and then compared with a reproduction control step determined at the reproduction stage, so that the reproduction of the program is selectively performed depending on the comparison result of the record control step and the reproduction control step.

### BACKGROUND OF THE INVENTION

1. Field of the Invention

The present invention relates to a device for selective recording and reproduction of video programs for video appliances which can guide juveniles to a sound direction by determining viewing-restriction steps (grades) for video programs and restricting juveniles' viewing of adult programs of violence and sex distributed through diverse video media.

2. Description of the Related Art

Diverse video media have appeared with popularity. Programs manufactured in various forms are distributed to general consumers without undergoing an austere censorship.

It is currently possible for anyone to view video programs prohibited to juveniles through diverse video reproducing appliances. The most common practice to prohibit such viewing is to distinguish the video programs for adults and for juveniles by simply labelling on the case of video media.

Under these circumstances, the video programs containing unsound or undesirable contents are exposed and conveyed to juveniles without being filtered. This harms juveniles' mental health and causes deviant behavior.

### SUMMARY OF THE INVENTION

It is an object of the present invention to solve the aforementioned problems, and to provide a device for selective recording of video programs for video appliances which can intercept randomly provided video programs that might adversely affect juveniles by determining viewing-restriction steps (grades) according to the contents of the programs when recording the video programs and controlling recording of the video programs provided from video media according to the determined viewing-restriction steps.

It is another object of the present invention to provide a device for selective reproduction of video programs for video appliances which can selectively reproduce the programs through viewing-restriction steps (grades) according to the contents of the programs.

In one aspect of the present invention, there is provided a device for selectively recording video programs for video appliances comprising:

a program selecting section for selecting one of the video programs provided from a plurality of the video appliances;

a control section for controlling recording of the program selected by the program selecting section in accordance with control signals which can be distinguished by a pulse or a combination of pulses, or inherent control signals generated from a control signal generating section of the control section;

a recording section for recording the selected program in accordance with the series of record control steps under the control of the control section; and

a video/audio output section for outputting video and audio signals of the program recorded by the recording section.

In another aspect of the present invention, there is provided a device for selectively reproducing video programs for video appliances comprising:

a deck section for placing therein a video tape to be reproduced;

a first determining section for determining a reproduction control step of the video tape placed in the deck section;

a coding section for qualifying the first determining section to determine the reproduction control step;

a discriminating section for recognizing a record control step of a video program recorded on the video tape and comparing the record control step with the reproduction control step determined by the first determining section;

a control section for determining whether to reproduce the program in accordance with a comparison result from the discriminating section;

a reproducing section for reproducing the program recorded on the video tape under the control of the control section; and

a video/audio output section for outputting video and audio signals of the program reproduced by the reproducing section.

### BRIEF DESCRIPTION OF H DRAWINGS

The above objects, other features and advantages of the present invention will become more apparent by describing the preferred embodiments thereof with reference to the accompanying drawings, in which:

FIG. 1 is a block diagram of the device for selectively recording video programs for video appliances according to the present invention.

FIG. 2 is a block diagram of the device for selectively reproducing video programs for video appliances according to one embodiment of the present invention.

FIG. 3 is a block diagram of the device for selectively reproducing video programs for video appliances according to another embodiment of the present invention.

FIG. 4 is a block diagram of the device for selectively reproducing video programs for video appliances according to still another embodiment of the present invention.

FIG. 5 illustrates a table explaining record/reproduction control steps according to the viewing grades according to the present invention.

### DESCRIPTION OF THE PREFERRED EMBODIMENTS

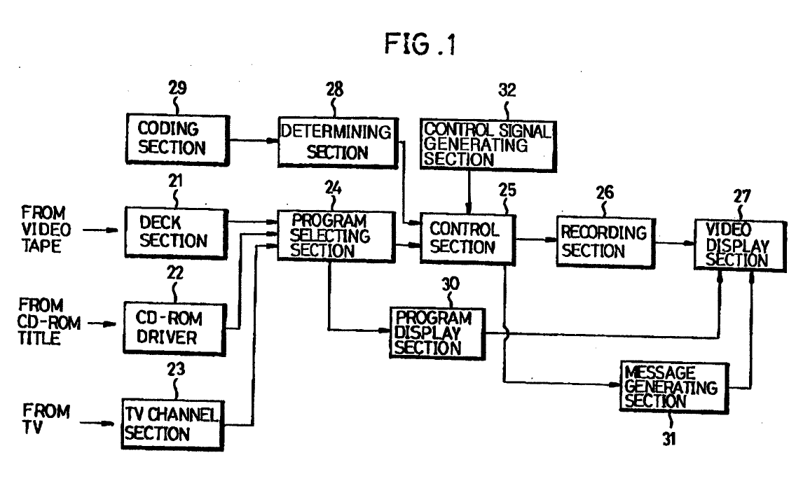

FIG. 1 is a block diagram of the device for selectively recording video programs for video appliances according to the present invention. Referring to FIG. 1, the recording device according to the present invention includes a program selecting section 24 for selecting one of video programs outputted from video appliances 21, 22, 23, a control section 25 for controlling recording of the program selected by the program selecting section 24 with a series or recording control steps, a recording section 26 for recording the selected program in accordance with the series of recording control steps under the control of the control section 25, and a video/audio output section 27 for outputting video and audio signals of the program recorded by the recording section 26.

The control section 25 determines three viewing restriction steps (grades) of programs, such as for adults only, for adults and juveniles (general audience), and for juveniles only, and controls the recording of the program to be performed according to the determined viewing-restriction steps (grades).

The selective recording device according to the present invention further includes a control signal generating section 32 for generating control signals which are distinguished by a pulse or a combination of pulses, or inherent control signals, so that the control section 25 controls the recording section 26 to record the control signals so as for the control section to recognize the viewing-restriction steps (grades), a determining section 28 for determining the viewing-restriction steps (grades) of the programs to be recorded; a coding section 29 for enabling/disabling the determining section 28 to determine the viewing-restriction steps (grades), a program display section 30 for receiving data from the program selecting section 24 and displaying the title and contents of the currently recorded program through the video/audio output section 27, and a message generating section 31 for receiving data from the control section 25 and displaying the state of the currently recorded program through the video/audio output section to notify the viewer of the state of the program.

In the embodiments, diverse video appliances connected to the program selection section 24 are a video deck section 21 in which the video tape is placed, a CD-ROM driver 22 in which a CD-ROM title is placed, and a TV channel section 23 for receiving a TV broadcasting signal.

The operation of the selective recording device according to the present invention will now be explained. A user who is an adult such as a parent or a guardian may input a code determined in the form of particular letters or numbers through the coding section 29 before recording a video medium to subsequently prevent a juvenile or a third person from arbitrarily manipulating the device.

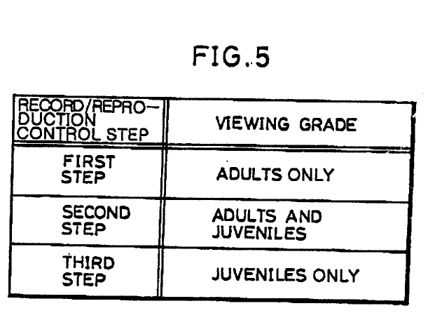

If the code is inputted as described above, the determining section 28 becomes ready to determine the recording control step which may be the Inputted code itself or an encoded form of the code. As illustrated in FIG. 5, one of the three steps should be determined according to the viewing object, i.e., viewing grade of the program.

After the determination of the record control step is completed, one of the video appliances may be selected to record the corresponding video program. For instance, a video deck section 21 in which a video tape is placed is connected if a video cassette recorder is selected, while a CD-ROM driver 22 is connected if a CD-ROM title is selected. A so, a TV channel section 23 is connected if a TV is selected.

If one of the video appliances 21, 22, 23 is selected and a corresponding program to be recorded is selected by the program selecting section 24, the control section 25 controls the recording section 26 to record the program according to the record control steps determined by the determining section 28.

The program being recorded by the recording section 26, is simultaneously displayed through the video/audio output section 27, while the title or the contents of the recorded program is also displayed through the video/audio output section 27 by the program display section 30.

As illustrated in FIG. 5, the record control steps controlled by the control section 25 may be classified into a first step for programs for adults only; a second step for programs for both adults and juveniles; and a third step for programs for juveniles only. in other words, a first step is determined for the programs that adults can exclusively watch, a second step is determined for the programs that are close to those for adults but not harmful so that adults (parents) and juveniles can watch together, and a third step is determined for the programs that are included in neither first nor second step programs and juveniles can exclusively watch.

If a user determines the first step through the determining section 28, the control signal produced by a pulse or a combination of pulses, or the inherent control signal corresponding to the step for a program for adults only is recorded in the recording medium together with the program itself by the recording section 26, so that the control signal can be recognized when the recorded program is reproduced. In other words, to distinguish the record control steps, a control signal formed by a pulse or a combination of pulses, or an inherent control signal is generated from the control signal generating section 32 corresponding to the record control step of the program to be recorded and is recorded on the recording medium together with the program. Particular control signals corresponding to the second and third steps will be recorded on the recording medium in the same manner as the first step. Here, in order to distinguish the control steps, it may be also preferable that the control signal generating section 32 generates inherent control signals.

The control section 25 also controls the message generating section 31 to display the recording control step through the video display section 27, so that the user can recognize the record control stop of the recorded program.

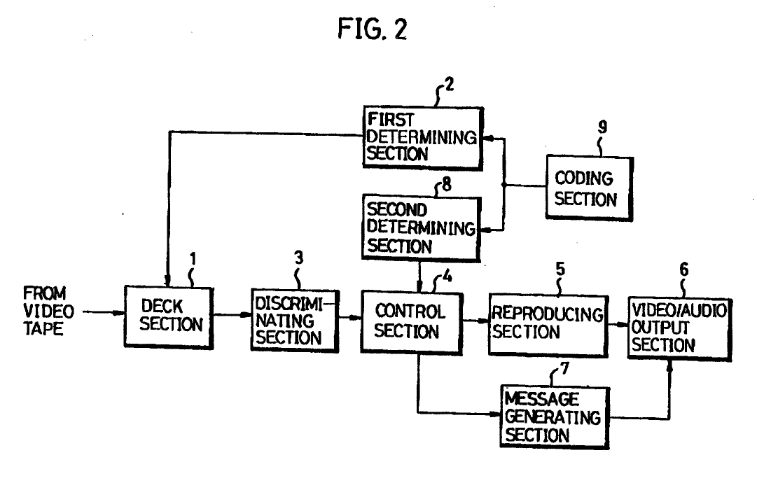

FIG. 2 is a block diagram of the device for selectively reproducing video programs for video appliances according to one embodiment of the present invention.

Referring to FIG. 2, the selective reproduction device according to the present invention includes a deck section 1 for placing therein a video tape to be reproduced, a first determining section 2 for determining a reproduction control step of the video tape in the deck section 1, a discriminating section 3 for recognizing a record control step of the program recorded on the video tape placed in the deck section 1 and comparing the recognized record control step with the reproduction control step determined by the first determining section 2, a control section 4 for determining whether to reproduce the program according to the comparison result from the discriminating section 3, a reproducing section 5 for reproducing the program recorded on the video tape under the control of the control section 4, a video/audio output section 6 for outputting video and audio signals of the program reproduced by the reproducing section 5, and a message generating section 7 for notifying a user of the current reproduction control step of the program reproduced by the reproducing section 5 through the video/audio output section 6 under the control of the control section 4.

The selective reproduction device according to the present invention further includes a second determining section 8 for redetermining or verifying the reproduction control step. Specifically, if the record control step obtained from the recorded program in the video tape does not correspond to the first determined reproduction control step as determined by the discriminating section 3, the second determining section 8 redetermines the reproduction control step as explained in more detail below. The selective reproduction device further includes a coding section 9 for qualifying the first determining section 2 and the second determining section 8 to determine the reproduction control step so that a juvenile or a third party may not arbitrarily manipulate the device.

According to the selective reproduction device according to one embodiment of the present invention, the video tape placed in the deck section 1 is reproduced with a series of reproduction control steps, so that reproduction is selectively performed depending on the viewing grade.

If the user inputs a code determined in the form of particular letters or numbers through the coding section 9, the first determining section 2 operates to determine the reproduction control steps.

As illustrated in FIG. 5, the reproduction control steps inputted by the user through the first determining section 2 are classified into three steps: 1) for programs for adults only, 2) for adults and juveniles, and 3) for juveniles only, as in the record control steps as described above.

The discriminating section 3 compares the input code with the determined code by the first determining section. If the two codes correspond to each other as a result of comparison, the control section 4 transfers the program signal read out from the video tape to the reproducing section 5.

The program reproduced as described above is outputted through the video/audio output section 6 for user's viewing. when the video and audio signals of the reproduced program are outputted, the control section 4 notifies the user of the reproduction control step of the program being reproduced.

However, if the record control step of the currently reproduced tape in the deck section 1 does not correspond to the reproduction control step determined by the user through the first determining section 2, the control section 4 prevents the reproducing section 5 from reproducing the recorded program, and notifies the user through the message generating section 7 and the video/audio output section 6 that the tape cannot be reproduced due to the determined record control step.

If the use redetermines through the second determining section 8 the reproduction control step to correspond to the record control step of the program to be reproduced, the control section 4 re-recognizes the redetermined reproduction control step and allows the reproducing section 5 to reproduce the recorded program.

As illustrated in FIG. 5, determination of the reproduction control step to be the first step enables reproduction of the program for adults only. Determination of the reproduction control step to be the Second stop enables reproduction of the program for adults and juveniles.

Determination of the reproduction control step to be the third step enables reproduction of the program for juveniles only.

For instance, if a reproduction control step has been determined to be the third step 50 that juveniles may not view the programs for adults only, the juveniles will be unable to reproduce and view the video tape in which the program for adults only has been recorded. Further, the juveniles will be unable to redetermine the reproduction control step through the second determining section 8 unless they know the particular code.

No problem arises when only one program has been recorded on one tape. When a plurality of programs have been recorded on one tape, especially when the programs for adults only and juveniles only have been recorded on one tape, however, it will be inconvenient for user's viewing. To solve this problem, another embodiment of the present invention has been proposed.

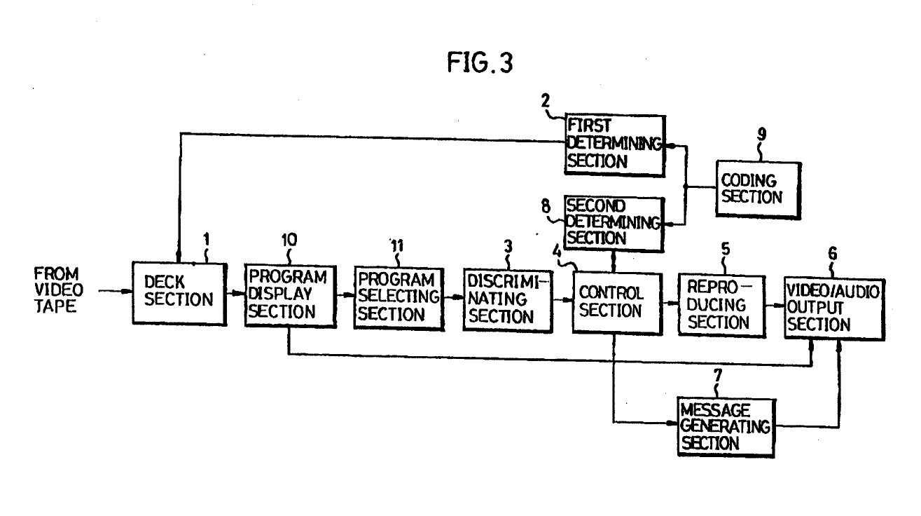

The construction and effect of the device for selectively reproducing video programs for video appliances according to another embodiment of the present invention will now be explained with reference to FIG. 3. The parts overlapping with the first embodiment will be referred to by the same reference numerals whose descriptions are omitted from the following explanation.

Referring to FIG. 3, the device for selectively reproducing video programs for video appliances according to another embodiment of the present invention includes a deck section 1 in which a video tape is placed, a first determining section 2 for determining a reproduction control step of the video tape placed in the deck section 1, a discriminating section 3 for recognizing the record control step of the program recorded on the video tape in the deck section 1 and comparing the recognized record control step with the reproduction control step determined by the first determining section 2, a control section 4 for determining whether to reproduce the program in accordance with the comparison result from the discriminating section 3, a reproducing section 5 for reproducing the program recorded on the video tape under the control of the control section 4, a video/audio output section. 6 for outputting video and audio signals of the program reproduced by the reproducing section 5, and a message generating section 7 for notifying the user of the current reproduction control step of the program reproduced by the reproducing section 5 through the video/audio output section 6 under the control of the control section 4.

The selective reproduction device according to another embodiment of the present invention further includes a second determining section 8 for redetermining or verifying the reproduction control step. Specifically, if the record control step obtained from the recorded program in the video tape does not correspond to the first determined reproduction control step as determined by the discriminating section 3, the second determining section 8 redetermines the reproduction control step as explained in more detail below. The selective reproduction device further includes a coding section 9 for qualifying the first determining section 2 and the second determining section 8 to determine the reproduction control step so that a juvenile or a third party may not arbitrarily manipulate the device, a program display section 10 for displaying a plurality of programs which have been recorded on the video tape in the deck section 1 through the video/audio output section 6, and a program selecting section 11 for selecting a desired program among the programs displayed through the program display section 10.

According to the selective reproducing device according to the second embodiment, if a video tape in which a plurality of programs of different grades are recorded is placed in the deck section 1, the program display section 10 displays the programs recorded on the tape through the video/audio output section 6.

If the user selects a desired program through the program selecting section 11 among the programs displayed by the video/audio output section 6, the discriminating section 3 compares the reproduction control step determined by the first determining section 2 with the record control stop determined and recorded on the video tape, and discriminates whether the two steps accord with each other for the selective reproduction as described in the first embodiment.

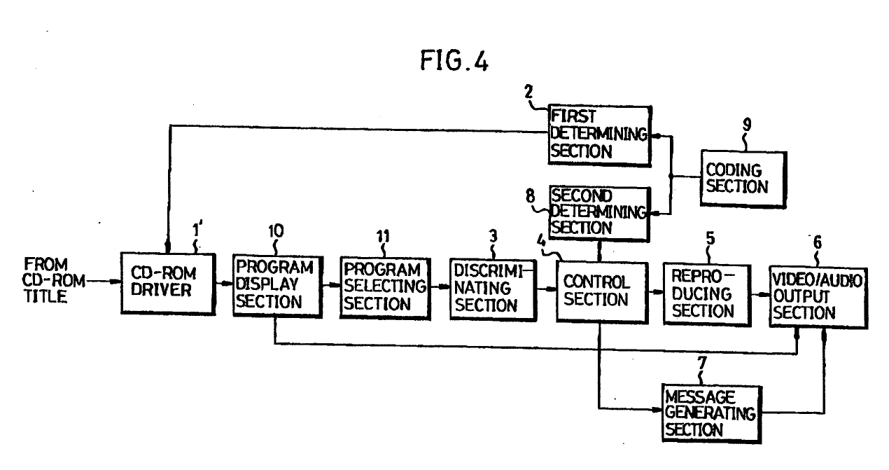

FIG. 4 is a block diagram of the device for selectively reproducing video programs for video appliances according to still another embodiment of the present invention. The construction and effect of this embodiment is the same as those of the second embodiment described above.

According to this embodiment, if a CD-ROM title such as a DVD (digital video disc) is placed in a CD-ROM driver 1′, a plurality of programs contained in the CD-ROM is reproduced and displayed through the video/audio output section 6. If the user selects a desired program among the reproduced program, the record control stop of the program contained in the CD-ROM title is compared with the reproduction control step determined by the first determining section 2 for selective reproduction.

As described above, according to the three embodiments of the present invention, the record control step of the program is recognized, and the reproduction control step for selective reproduction is determined depending on the viewing object. Thus, a selective reproduction of a video medium is performed according to the determined reproduction control step.

From the foregoing, the present invention provides a selective recording and reproduction device of video programs which can restrict viewing of the program that may harm mental health of juveniles and thus serve for mental health and sound culture of the juveniles by selectively recording and reproducing a video program depending on the viewing grade thereof.

While the present invention has been described and illustrated herein with reference to the preferred embodiments thereof, it will be understood by those skilled in the art that various changes in form and details may be made therein without departing from the spirit and scope of the invention.

What is claimed is:

1. A device for selectively recording video programs f or video appliances comprising:
a program selecting section f or selecting one of the video programs provided from a plurality of the video appliances;
a control section for controlling recording of the program selected by the program selecting section in accordance with control signals which can be distinguished by a pulse or a combination of pulses, or inherent control signals generated from a control signal generating section of the control section;
a recording section for recording the selected program with a signal indicative of one of a plurality of record control steps that represent content gradings of the video programs f or purposes of subsequently preventing reproduction of the recorded program; and
a video/audio output section for outputting video and audio signals of the program recorded by the recording section.

2. A device f or selectively recording video programs for video appliances comprising:
a program selecting section for selecting one of the video programs provided from a plurality of the video appliances;
a control section for controlling recording of the program selected by the program selecting section according to one of a plurality of record control steps in accordance with control signals which can be distinguished by a pulse or a combination of pulses, or inherent control signals generated from a control signal generating section of the control section;
a recording section for recording the selected program in accordance with the record control steps under the control of the control section;
a video/audio output section for outputting video and audio signals of the program recorded by the recording section; and
a program display section for receiving data from the program selecting section and displaying a title or contents of the program through the video/audio output section.

3. A device for selectively recording video programs for video appliances comprising:
a program selecting section for selecting one of the video programs provided from a plurality of the video appliances;
a control section for controlling recording of the program selected by the program selecting section with a series of record control steps in accordance with control signals which can be distinguished by a pulse or a combination of pulses, or inherent control signals generated from a control signal generating section of the control section;
a recording section for recording the selected program in accordance with the series of record control steps under the control of the control section;
a video/audio output section for outputting video and audio signal of the programs recorded by the recording section; and
a message generating section for receiving data from the control section and displaying the state of the program recorded by the recording section through the video/audio output section.

4. A device for selectively recording video programs for video appliances comprising:
a program selecting section for selecting one of the video programs provided from a plurality of the video appliances; and
a control section for controlling recording of the program selected by the program selecting section with a series of record control steps in accordance with control signals which can be distinguished by a pulse or a combination of pulses, or inherent control signals generated from a control signal generating section;
wherein the series of record control steps includes a first step for programs for adults only, a second stop for programs for adults and juveniles, and a third step for programs for juveniles only.

5. A device for selectively recording video programs for video appliances comprising:
a program selecting section for selecting one of the video programs provided from a plurality of the video appliances;
a control section for controlling recording of the program selected by the program selecting section with a series of record control steps in accordance with control signals which can be distinguished by a pulse or a combination of pulses, or inherent control signals generated from a control signal generating section of the control section;
a recording section for recording the selected program in accordance with the series of record control steps under the control of the control section;
a video display section for displaying on a display screen the program recorded by the recording section;
a determining section for determining the record control steps so as to enable the control section to control the recording of the program according to the determined record control steps; and
a coding section for qualifying the determining section to determine the record control steps.

6. A device for selectively reproducing video programs for video appliances comprising:
a deck section for placing therein a video tape to be reproduced;
a first determining section for determining one of a plurality of reproduction control steps of the video tape placed in the deck section, the reproduction control steps being representative of content gradings of video programs;
a coding section for qualifying the first determining section to determine the reproduction control step;
a discriminating section for recognizing a record control step of a video program recorded on the video tape and comparing the record control step with the reproduction control step determined by the first determining section;
a control section for determining whether to reproduce the program in accordance with a comparison result from the discriminating section;
a reproducing section for reproducing the program recorded on the video tape under the control of the control section; and
a video/audio output section for outputting video and audio signals of the program reproduced by the reproducing section.

7. A device for selectively reproducing video programs for video appliances comprising:
a deck section for placing therein a video tape to be reproduced;
a first determining section for determining a reproduction control step of the video tape placed in the dock section;
a discriminating section for recognizing a record control step of a video program recorded on the video tape and comparing the record control step with the reproduction control step determined by the first determining section;
a control section for determining whether to reproduce the program in accordance with a comparison result from the discriminating section;
a second determining section for redetermining the reproduction control step to accord with the record control step of the program recorded on the video tape if the record control step discords with the firstly determined reproduction control step as a comparison result from the discriminating section; and
a coding section for qualifying the first and second determining sections to determine the reproduction control step.

8. A device for selectively reproducing video programs for video appliances comprising:
a deck section for placing therein a video tape to be reproduced;
a first determining section for determining a reproduction control step of the video tape placed in the deck section;
a coding section for qualifying the first determining section to determine the reproduction control step;
a discriminating section for recognizing a record control step of a video program recorded on the video tape and comparing the record control step with the reproduction control stop determined by the first determining section;
a control section for determining whether to reproduce the program in accordance with a comparison result from the discriminating section; and
a message generating section for notifying a user of the current reproduction control step of the reproduced program under the control of the control section.

9. A device for selectively reproducing video programs for video appliances comprising:
a deck section for placing therein a video tape to be reproduced;
a first determining section for determining a reproduction control step of the video tape placed in the deck section;
a coding section for qualifying the first determining section to determine the reproduction control step;
a discriminating section for recognizing a record control step of a video program recorded on the video tape and comparing the record control step with the reproduction control step determined by the first determining section; and
a control section for determining whether to reproduce the program in accordance with a comparison result from the discriminating section;
wherein the series of reproduction control steps includes a first step for programs for adults only, a second step for programs for adults and juveniles, and a third step for programs for juveniles only.

10. A device for selectively reproducing video programs for video appliances comprising:
a deck section for placing therein a video tape to be reproduced;
a first determining section for determining a reproduction control step of the video tape placed in the deck section;
a coding section for qualifying the first determining section to determine the reproduction control step;
a program display section for displaying various kinds of programs mixedly recorded on the video tape;
a program selecting section for selecting a desired program among the programs displayed by the program display section;
a discriminating section for recognizing a record control step of a video program recorded on the video tape and comparing the record control step with the reproduction control step determined by the first determining section;
a control section for determining whether to reproduce the program in accordance with a comparison result from the discriminating section;
a reproducing section for reproducing the program recorded on the video tape under the control of the control section; and
a video/audio output section for outputting video and audio signals of the program reproduced by the reproducing section.

11. A device for selectively reproducing video programs for video appliances comprising:
a deck section for placing therein a video tape to be reproduced;
a first determining section for determining a reproduction control step of the video tape placed in the deck section;
a coding section for qualifying the first determining section to determine the reproduction control step;
a program selecting section for selecting a desired program among various kinds of programs mixedly recorded on the video tape;
a discriminating section for recognizing a record control step of a video program recorded on the video tape and comparing the record control step with the reproduction control step determined by the first determining section;
a control section for determining whether to reproduce the program in accordance with a comparison result from the discriminating section;
a reproducing section for reproducing the program recorded on the video tape under the control of the control section; and
a video/audio output section for outputting video and audio signals of the program reproduced by the reproducing section.

12. A device for selectively reproducing video programs for video appliances comprising:
a deck section for placing therein a video tape to be reproduced;
a first determining section for determining a reproduction control step of the video tape placed in the deck section;
a program display section for displaying various kinds of programs mixedly recorded on the video tape;
a program selecting section for selecting a desired program among the programs displayed by the program display section;
a discriminating section for recognizing a record control step of a video program recorded on the video tape and comparing the record control step with the reproduction control step determined by the first determining section;
a control section for determining whether to reproduce the program in accordance with a comparison result from the discriminating section;
a second determining section for redetermining the reproduction control step to accord with the record control step of the recorded program if the record control step discords with the determined reproduction control step as the comparison result from the discriminating section; and
a coding section for qualifying the first and second determining sections to determine the reproduction control step.

13. A device for selectively reproducing video programs for video appliances comprising:
a deck section for placing therein a video tape to be reproduced;
a first determining section for determining a reproduction control step of the video tape placed in the deck section;
a coding section for qualifying the first determining section to determine the reproduction control step;
a program display section for displaying various kinds of programs mixedly recorded on the video tape;
a program selecting section for selecting a desired program among the programs displayed by the program display section;
a discriminating section for recognizing a record control stop of a video program recorded on the video tape and comparing the record control step with the reproduction control stop determined by the first determining section;
a control section for determining whether to reproduce the program in accordance with a comparison result from the discriminating section; and
a message generating section for notifying the user of the current reproduction control step of the program under the control of the control section.

14. A device for selectively reproducing video programs for video appliances comprising:
a deck section for placing therein a video tape to be reproduced;
a first determining section for determining a reproduction control step of the video tape placed in the deck section;
a coding section for qualifying the first determining section to determine the reproduction control step;
a program display section for displaying various kinds of programs mixedly recorded on the video tape;
a program selecting section for selecting a desired program among the programs displayed by the program display section;
a discriminating section for recognizing a record control step of a video program recorded on the video tape and comparing the record control step with the reproduction control step determined by the first determining section; and
a control section for determining whether to reproduce the program in accordance with a comparison result from the discriminating section;
wherein the series of reproduction control steps includes a first step for programs for adults only, a second step for programs for adults and juveniles, and a third step for programs for juveniles only.

15. A device for selectively reproducing video programs for video appliances comprising:
a CD-ROM driver for placing therein a CD-ROM title to be reproduced;
a first determining section for determining a reproduction control step of the CD-ROM title placed in the CD-ROM driver;
a coding section for qualifying the first determining section to determine the reproduction control step;
a program display section for displaying various kinds of programs mixedly recorded on the CD-ROM title;
a program selecting section for selecting a desired program among the programs displayed by the program display section;
a discriminating section for recognizing a record control step of a video program recorded on the CD-ROM title and comparing the record control step with the reproduction control step determined by the first determining section;
a control section for determining whether to reproduce the program in accordance with a comparison result from the discriminating section;
a reproducing section for reproducing the program recorded on the CD-ROM title under the control of the control section; and
a video/audio output section for outputting video and audio signals of the program reproduced by the reproducing section.

16. A device for selectively reproducing video programs for video appliances comprising:
a CD-ROM driver for placing therein a CD-ROM title to be reproduced;
a first determining section for determining a reproduction control stop of the CD-ROM title placed in the CD-ROM driver;
a coding section for qualifying the first determining section to determine the reproduction control step;
a program selecting section for selecting a desired program among various kinds of programs mixedly recorded on the CD-ROM title;
a discriminating section for recognizing a record control step of a video program recorded on the CD-ROM title and comparing the record control step with the reproduction control step determined by the first determining section;
a control section for determining whether to reproduce the program in accordance with a comparison result from the discriminating section;
a reproducing section for reproducing the program recorded on the CD-ROM title under the control of the control section; and
a video/audio output section for outputting video and audio signals of the program reproduced by the reproducing section.

17. A device for selectively reproducing video programs for video appliances comprising:
a CD-ROM driver for placing therein a CD-ROM title to be reproduced;
a first determining section for determining a reproduction control step of the CD-ROM title placed in the CD-ROM driver;
a program display section for displaying various kinds of programs mixedly recorded on the CD-ROM title;
a program selecting section for selecting a desired program among the programs displayed by the program display section;
a discriminating section for recognizing a record control step of a video program recorded on the CD-ROM title and comparing the record control step with the reproduction control step determined by the first determining section;
a control section for determining whether to reproduce the program in accordance with a comparison result from the discriminating section;
a second determining section for redetermining the reproduction control step to accord with the record control step of the program recorded on the CD-ROM title if the record control step discords with the determined reproduction control step as the comparison result from the discriminating section; and
a coding section for qualifying the first and second determining sections to determine the reproduction control step.

18. A device for selectively reproducing video programs for video appliances comprising:
a CD-ROM driver for placing therein a CD-ROM title to be reproduced;
a first determining section for determining a reproduction control step of the CD-ROM title placed in the CD-ROM driver;
a coding section for qualifying the first determining section to determine the reproduction control step;
a program display section for displaying various kinds of programs mixedly recorded on the CD-ROM title;
a program selecting section for selecting a desired program among the programs displayed by the program display section;
a discriminating section for recognizing a record control step of a video program recorded on the CD-ROM title and comparing the record control step with the reproduction control step determined by the first determining section;
a control section for determining whether to reproduce the program in accordance with a comparison result from the discriminating section; and
a message generating section for notifying the user of the current reproduction control step of the program under the control of the control section.

19. A device for selectively reproducing video programs for video appliances comprising:
a CD-ROM driver for placing therein a CD-ROM title to be reproduced;
a first determining section for determining a reproduction control step of the CD-ROM title placed in the CD-ROM driver;
a coding section for qualifying the first determining section to determine the reproduction control step;
a program display section for displaying various kinds of programs mixedly recorded on the CD-ROM title;
a program selecting section for selecting a desired program among the programs displayed by the program display section;
a discriminating section for recognizing a record control step of a video program recorded on the CD-ROM title and comparing the record control step with the reproduction control step determined by the first determining section; and
a control section for determining whether to reproduce the program in accordance with a comparison result from the discriminating section;
wherein the series of reproduction control steps includes a first step for programs for adults only, a second step for programs for adults and juveniles, and a third step for programs for juveniles only.

20. A device for selectively recording/reproducing video programs for video appliances comprising:
a program selecting section for selecting one of the video programs to be recorded/reproduced, which are provided from a plurality of the video appliances;
a control section for controlling record/reproduction of the program selected by the program selecting section in accordance with record/reproduction viewing-restriction steps (grades);
a record/reproduction section for performing record/reproduction of the program controlled by the control section based on at least two record/reproduction viewing-restriction steps (grades) including a first step for a program for adults only and a second step for a program for juveniles only, which are determined by a determining section, in accordance with control signals distinguished by a pulse or a combination of pulses, or inherent control signals generated from a control signal generating section of the control section; and
a video/audio output section for outputting video and audio signals of the program recorded/reproduced by the record/reproduction section.
